(19) United States
(12) Patent Application Publication
(10) Pub. No.: US 2016/0363465 A1
(43) Pub. Date: Dec. 15, 2016

(54) PROXIMITY SENSOR AND DETECTION METHOD THEREOF

(71) Applicant: uPI Semiconductor Corp., Hsinchu County (TW)

(72) Inventors: Kuo-Liang Teng, Hsinchu County (TW); Jih-Liang Juang, Hsinchu County (TW)

(21) Appl. No.: 14/924,724

(22) Filed: Oct. 28, 2015

(30) Foreign Application Priority Data
Jun. 12, 2015 (TW) 104119105

(51) Int. Cl. G01D 5/40

(52) U.S. Cl. CPC G01D 5/40

(57) ABSTRACT

A proximity sensor and a detection method thereof are provided. The proximity sensor includes the proximity sensing unit and a control unit. The proximity sensing unit generates a sensing value in response to an object. The control unit is coupled to the proximity sensing unit. The control unit obtains the sensing value from the proximity sensing unit, compares the sensing value and a default value to obtain a comparing result, calculates a status accumulative time according to the comparing result, and determines whether the status accumulative time exceeds a default time, so as to determine a proximity status of the object.

### CROSS-REFERENCE TO RELATED APPLICATION

This application claims the priority benefit of Taiwan application serial no. 104119105, filed on Jun. 12, 2015. The entirety of the above-mentioned patent application is hereby incorporated by reference herein and made a part of this specification.

### BACKGROUND OF THE INVENTION

Field of the Invention

The invention relates to a proximity sensing technique, and particularly relates to a proximity sensor and a detection method thereof.

Description of Related Art

Along with development of technology and conveniences brought to people, electronic devices (for example, mobile phones, tablets, personal computers (PCs), etc.) gradually become indispensable in people's life and work. The present electronic devices generally have a plurality of sensors (for example, a proximity sensor, an acceleration sensor, a pressure sensor, etc.) for assisting a plurality of functions (for example, screen switching, navigation, etc.) on the electronic devices or providing a plurality of sensing information (for example, temperature, pressure, etc.) to people.

The proximity sensor is a sensor capable of detecting whether an object is approaching without a physical contact, in which a sensing chip sends a report signal to a microprocessor to notify whether the object is in a proximity status or in an away status. However, in an actual application, the existing proximity sensor is often influenced by other external factors to cause a wrong judgment.

For example, an optical proximity sensor is generally configured with a light emitting diode (LED) which emits light with a specific wave length (for example, 850 nm, 940 nm, etc.) or an infrared ray (IR) emitter, and the optical proximity sensor detects a reflected light of the light reflected by an object to determine whether the object is approaching. However, when the optical proximity sensor faces a strong light, or a rapid surge is incident to the optical proximity sensor, the sensing chip always misjudges that the object moves away. FIG. 1 is a solar spectrum analysis diagram, in which a vertical axis represents light intensity, and a horizontal axis represents wavelength (with a unit of nanometer). Referring to FIG. 1, when the wavelength is 850 nm or 940 nm, distribution of the solar spectrum is not zero. Therefore, irradiated by a strong sunlight, the proximity sensor can still sense the light with the wavelength of 850 nm or 940 nm, which causes the wrong judgement that the object moves away. An optical surge of the electronic device caused by environmental light variation may also cause a wrong judgment of the sensing chip or microprocessor disposed on the electronic device. Moreover, an existing anti-glare algorithm is required to be implemented in the sensing chip or the microprocessor, which probably causes increase of a chip area. In addition, the optical proximity sensor with the fixed light wavelength (for example, 850 nm or 940 nm) is required to have higher quality, so that fabrication cost thereof is relatively high.

### SUMMARY OF THE INVENTION

The invention is directed to a proximity sensor and a detection method of the proximity sensor, by which wrong judgement is mitigated.

The invention provides a detection method of a proximity sensor, which includes following steps: (a) obtaining a sensing value from a proximity sensing unit; (b) comparing the sensing value and a default value to obtain a comparing result, and calculating a status accumulative time according to the comparing result; and (c) determining whether the status accumulative time exceeds a default time, so as to determine a proximity status of an object.

The invention provides a proximity sensor including a proximity sensing unit and a control unit. The proximity sensing unit generates a sensing value in response to an object. The control unit is coupled to the proximity sensing unit. The control unit obtains the sensing value from the proximity sensing unit, compares the sensing value and a default value to obtain a comparing result, calculates a status accumulative time according to the comparing result, and determines whether the status accumulative time exceeds a default time, so as to determine a proximity status of the object.

According to the above descriptions, the proximity sensor and the detection method of the proximity sensor of the invention are adapted to read the sensing values for multiple times, and successively accumulate the status accumulative time to determine whether the object is in the proximity status or an away status. In this way, determination accuracy is effectively improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a solar spectrum analysis diagram.

FIG. 2 is a circuit block schematic diagram of a proximity sensor according to an embodiment of the invention.

FIG. 3 is a signal diagram of an interrupt pin.

FIG. 4 is a flowchart illustrating a detection method of a proximity sensor according to an embodiment of the invention.

FIG. 5 is a flowchart of an interrupt mode.

FIG. 6 is a flowchart illustrating a method for determining whether an object is approaching or moves away.

FIG. 7 is a flowchart illustrating a trigger mode of an application program.

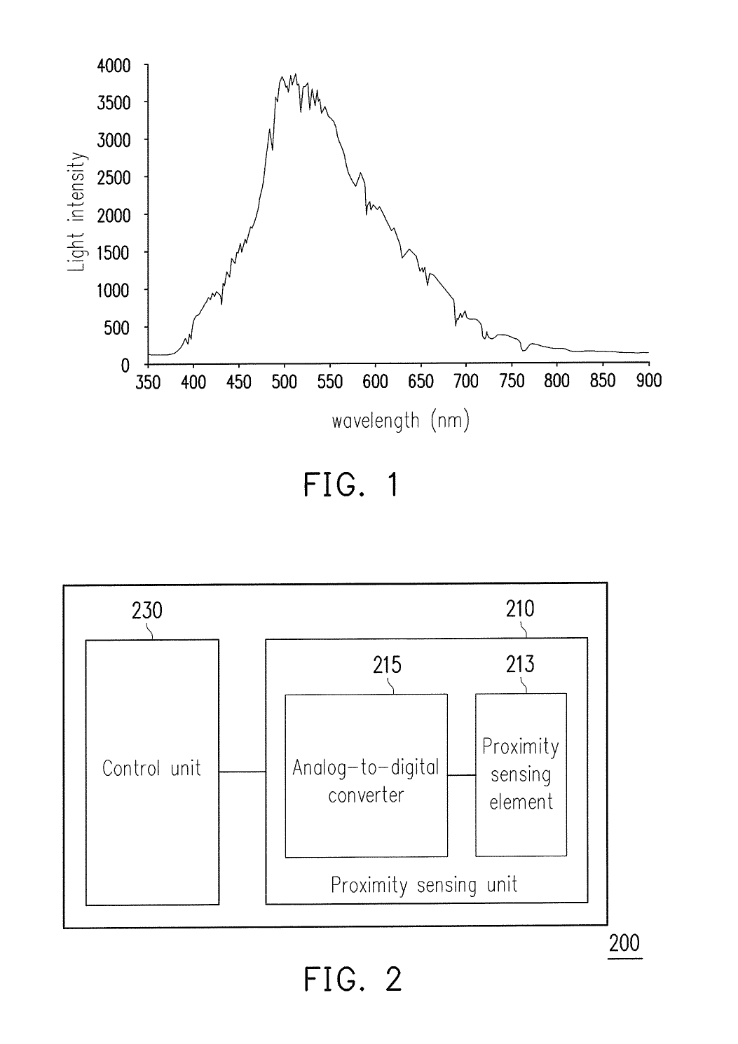

### DESCRIPTION OF EMBODIMENTS

FIG. 2 is a circuit block schematic diagram of a proximity sensor 200 according to an embodiment of the invention. In different application situations, the proximity sensor 200 can be built in smart phones, tablet personal computers (PCs), smart TVs, devices in the Internet of things (IoT) or other electronic devices. Referring to FIG. 2, the proximity sensor 200 includes a proximity sensing unit 210 and a control unit 230.

According to different design requirements, the proximity sensing unit 210 may include a proximity sensing element 213 and an analog-to-digital converter (ADC) 215. The proximity sensing element 213 is, for example, a sensing element of any sensing technique such as a capacitive, an optical, a magnetic sensing techniques, etc., and generates a sensing signal in response to an object (for example, a hand, a head, etc.). The proximity sensing element 213 is, for example, an optical proximity sensing element, though the invention is not limited thereto. The proximity sensing element 213 may emit an infrared light (or a light with other wavelength) to external of the proximity sensor 200. When the object (for example, the head) approaches the proximity sensing element 213, the proximity sensing element 213 can receive a reflected infrared light reflected by the object, and generates a sensing signal in response to the reflected infrared light. The ADC 215 is coupled to the proximity sensing element 213, and is used for converting the sensing signal of the proximity sensing element 213 into a sensing value. For example, the ADC 215 can sample the sensing signal sensed by the proximity sensing element 213 in a sampling rate of 180 Hz, and quantifies the sampled values for converting into the sensing value.

The control unit 230 is coupled to the proximity sensing unit 210, and receives the sensing value from the proximity sensing unit 210. The control unit 230 may include a central processing unit (or a central processor), a microprocessor, a micro controller, an application specific integrated circuit (ASIC), a chipset and/or other operation circuits. According to different design requirements, firmware and/or software can be executed by the control unit 230.

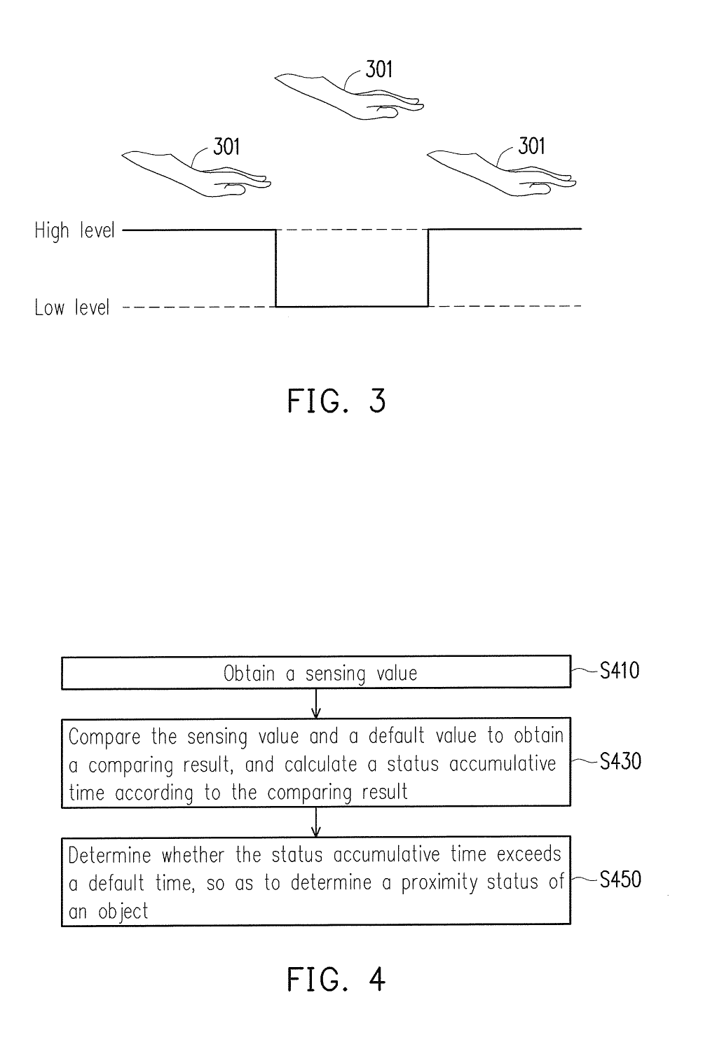

According to different design requirements, the proximity sensing unit 210 and the control unit 230 may have interrupt pins coupled to each other, and the control unit 230 may trigger an interrupt event according to a signal on the interrupt pin. For example, FIG. 3 is a signal diagram of the interrupt pin. Referring to FIG. 3, it is assumed that a hand 301 approaches the proximity sensing unit 210 (for example, the hand 301 located to the left approaches to the underneath), the signal at the interrupt pin has a high level. Comparatively, if the hand 301 is away from the proximity sensing unit 210 (for example, the hand 301 located in the middle is away from the underneath compared with the hand 301 located to the left), signal at the interrupt pin has a low level. In some embodiment, when the signal of the interrupt pin is changed from the high level to the low level, or is changed from the low level to the high level, the control unit 230 triggers the interrupt event.

According to different design requirements, the proximity sensor 200 of the invention can be built in an electronic device such as a mobile phone, a tablet, a notebook computer, etc., and can report an approach status or an away status of an object to a processing unit (for example, CPU, a chipset, etc.) of the electronic device, so as to provide a plurality of proximity sensing applications (for example, screen switching, a power saving function, etc.). For example, when the mobile phone configured with the proximity sensor 200 receives a call, the proximity sensor 200 may report the approach status or away status of the object to the processing unit (not shown) of the mobile phone to determine whether to turn off the screen (not shown) of the mobile phone.

In other embodiments, the proximity sensor 200 may include a storage unit (not shown) such as a register, a buffer or a memory, etc., and the storage unit is used for storing or setting a default value, a status accumulative time, a time interval dT and/or a default time. For example, the storage unit (not shown) can record the sensing value of the ADC 215 for the control unit 230 to read. According to different design requirements, the storage unit (not shown) can be a dynamic random access memory (DRAM), a static random access memory (SRAM), a volatile memory (VM) or a non-volatile memory (NVM).

FIG. 4 is a flowchart illustrating a detection method of a proximity sensor 200 according to an embodiment of the invention. Referring to FIG. 4, the detection method of the embodiment is adapted to the proximity sensor 200 of FIG. 2. In the following description, the detection method of the embodiment of the invention is described with reference of various components and modules in the proximity sensor 200. The flow of the method can be adjusted according to an actual application, and is not limited to the presented flow.

In step S410, the control unit 230 obtains a sensing value from the proximity sensing unit 210. To be specific, generation of the sensing value by the proximity sensing unit 210 may refer to related description of the proximity sensing unit 210 of FIG. 2, and details thereof is not repeated. The control unit 230 may read the sensing value in the ADC 215 or a storage unit (not shown) in a polling manner. The control unit 230 can periodically (for example, 10 times per second, 20 times per second) or irregularly (for example, a first period is 0.02 second, a second period is 0.03 second, etc.) obtains the sensing value from the proximity sensing unit 210, which is not limited by the invention.

It should be noticed that in an embodiment, before the step S410, if the control unit 230 receives an interrupt signal produced by the proximity sensing unit 210 in response to approaching of the object or a trigger event triggered by an application program related to the proximity sensing unit 210, it executes a read operation of obtaining the sensing value from the proximity sensing unit 210 for the first time. The method for generating the interrupt signal may refer to related description of the interrupt pins, and details thereof are not repeated. The application program is, for example, a telephone program, and the trigger event is, for example, an incoming call. Alternatively, the application program is, for example, a screen luminance adjustment program, and the trigger event is screen turn-on. It should be noted that the type of the application program and the corresponding trigger event can be adjusted according to an actual design requirement, and the embodiment of the invention is not limited thereto.

In step S430, the control unit 230 compares the sensing value of the proximity sensing unit 210 and a default value to obtain a comparing result, calculates a status accumulative time according to the comparing result. For example (though the invention is not limited thereto), the status accumulative time may include an object approach accumulative time dT_A and/or an object away accumulative time dT_B. In the present embodiment, the control unit 230 determines whether the sensing value exceeds the default value. If the sensing value exceeds the default value, the control unit 230 accumulates the object approach accumulative time dT_A of the status accumulative time. If the sensing value is less than the default value, the control unit 230 accumulates the object away accumulative time dT_B of the status accumulative time.

In an embodiment, the control unit 230 calculates a time interval dT between a time point corresponding to current read operation of the sensing value and a time point corresponding to previous read operation of the sensing value, and accumulates the time interval dT to the object approach accumulative time dT_A or the object away accumulative time dT_B. To be specific, if the control unit 230 periodically (for example, every 0.01 second, 0.03 second, etc.) executes the read operation, the control unit 230 may take a period of the periodic read operation as the time interval dT. Alternatively, the control unit 230 can record the time point of each read operation, and subtracts the time point of the current read operation by the time point of the previous read operation to obtain the time interval dT. If the sensing value presently obtained by the control unit 230 is greater than the default value, the object approach accumulative time dT_A and the time interval dT are added, and the added value is updated to the object approach accumulative time dT_A. For example, the default value is 100, and the currently read sensing value is 150, the control unit 230 adds the original object approach accumulative time dT_A (for example, 0.05 second) by the time interval dT (for example, 0.01 second), and updates the new object approach accumulative time dT_A to 0.06 second. If the sensing value presently obtained by the control unit 230 is smaller than the default value, the object away accumulative time dT_B and the time interval dT are added, and the added value is updated to the object away accumulative time dT_B. For example, the default value is 80, and the currently read sensing value is 50, the control unit 230 adds the object away accumulative time dT_B (for example, 0.03 second) by the time interval dT (for example, 0.02 second), and updates the object away accumulative time dT_B to 0.05 second.

In an embodiment, if the control unit 230 accumulates the object approach accumulative time dT_A, the control unit 230 initializes the object away accumulative time dT_B, and if the control unit 230 accumulates the object away accumulative time dT_B, the control unit 230 initializes the object approach accumulative time dT_A. In other words, if the sensing value is greater than the default value, the control unit 230 initializes the object away accumulative time dT_B. If the sensing value is smaller than the default value, the control unit 230 initializes the object approach accumulative time dT_A. Regarding an initialisation method, the control unit 230 can set the object approach accumulative time dT_A or the object away accumulative time dT_B to an initial time (for example, 0 second, 0.03 second, etc.).

It should be noted that before the object approach accumulative time dT_A or the object away accumulative time dT_B is updated, in an embodiment, if the control unit 230 determines that the read operation of obtaining the sensing value from the proximity sensing unit 210 is executed for the first time, the control unit 230 initializes the time interval dT and the status accumulative time. For example (though the invention is not limited thereto), the control unit 230 can initialize the object approach accumulative time dT_A and/or the object away accumulative time dT_B. To be specific, after the control unit 230 determines that the read operation is executed for the first time according to the interrupt signal or the trigger event, the control unit 230 respectively sets the time interval dT, the object approach accumulative time dT_A and the object away accumulative time dT_B to an initial time interval (for example, 0 second, 0.02 second, etc.), an initial object approach accumulative time (for example, 0 second, 0.03 second, etc.) and an initial object away accumulative time (for example, 0 second, 0.01 second, etc.).

Moreover, the default value can be related to a rated distance of the detected object, related to a material (for example, glass, plastic, etc.) of a cover layer of the proximity sensing unit 210, and related to a thickness, color or other physical parameters of the cover layer. The default value can be changed by those skilled in the art according to an actual design requirement.

After the status accumulative time (for example, the object approach accumulative time dT_A and/or the object away accumulative time dT_B) is updated, in step S450, the control unit 230 determines whether the status accumulative time (for example, the object approach accumulative time dT_A and/or the object away accumulative time dT_B) exceeds a default time, so as to determine a proximity status of the object.

In an embodiment, if the object approach accumulative time dT_A is greater than the default time, the control unit 230 determines the proximity status to be approach, and if the object away accumulative time dT_B is greater than the default time, the control unit 230 determines the proximity status to be away. For example, it is assumed that the default time is 0.02 second, and the updated object approach accumulative time dT_A is 0.021 second, the control unit 230 determines that the proximity status to be approach. It is assumed that the default time is 0.03 second, and the updated object away accumulative time dT_B is 0.032 second, the control unit 230 determines that the proximity status to be away.

The default time can be between a retardation lower limit time (for example, 3 or 4 conversion periods of the ADC 215 (for example, the period for converting the sensing signal into the sensing value) and a retardation upper limit time (for example, 0.1 second, 0.2 second, etc.).

According to different design requirements, the control unit 230 can further report the determination result (the object is in the approach status or the away status) to an external electronic device (for example, a mobile phone, a tablet, etc., which is not shown), or report the determination result to other processing unit (not shown) coupled to the control unit 230 for generating/triggering a corresponding function (for example, to turn on the screen, turn off the screen or hang up the call, etc.).

If the status accumulative time (for example, the object approach accumulative time dT_A and/or the object away accumulative time dT_B) is smaller than the default time, the control unit 230 does not update the proximity status of the object, and again obtains the updated sensing value from the proximity sensing unit 210, and the flow returns to the step S430. For example, if the object approach accumulative time dT_A and the object away accumulative time dT_B are all smaller than the default time, the control unit 230 repeats the step S410, and after the sensing value is obtained, the steps S430 and S450 are executed until the control unit 230 determines the proximity status of the object to be the approach status or away status (i.e. the object approach accumulative time dT_A is greater than the default time or the object away accumulative time dT_B is greater than the default time). It should be noted that the control unit 230 may wait a period of time (for example, the same to the conversion period of the ADC 215 or 0.02 second, 0.01 second, etc.) first, and then executes a next read operation.

In this way, in the embodiment of the invention, the proximity status (for example, the approach status or the away status) of the object is confirmed by determining the object approach accumulative time dT_A and the object away accumulative time dT_B, and compared with the technique of determining whether the object is approaching only through the interrupt signal, the embodiment of the invention can avoid the wrong judgement caused by external factors such as a strong light or an optical surge, etc. In order to help understanding the whole operation flow of the embodiment of the invention, two other application situations are provided below for description.

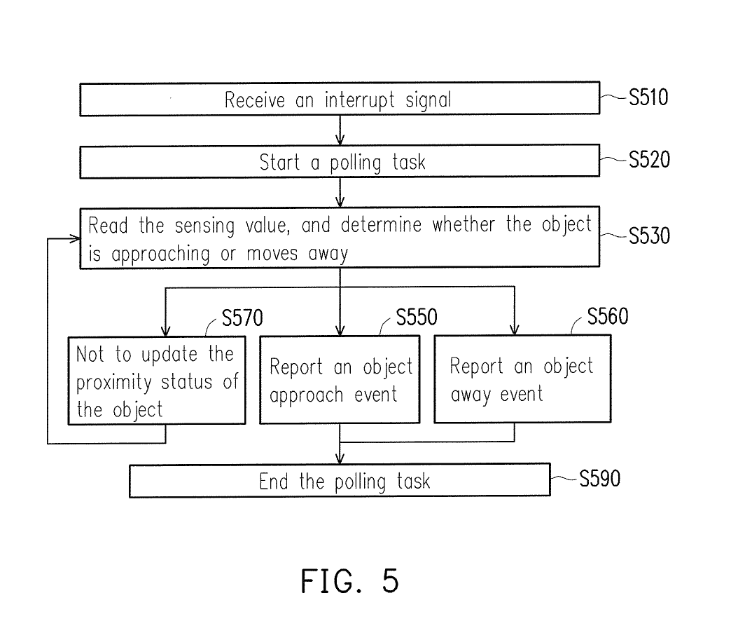

In view of the first application situation, FIG. 5 is a flowchart of an interrupt mode. Referring to FIG. 5, in step S510, the control unit 230 receives the interrupt signal from the proximity sensing unit 210 through the interrupt pin, and starts a polling task (step S520). Then, in step S530, the control unit 230 reads the sensing value of the proximity sensing unit 210, and determines whether the object is approaching or moves away.

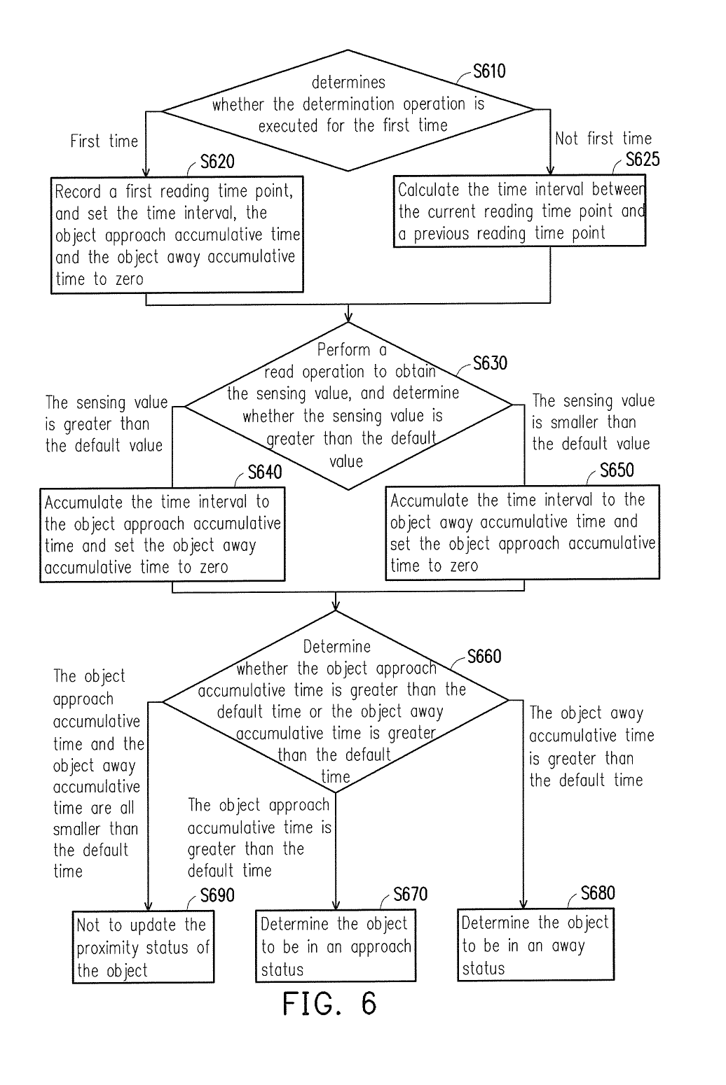

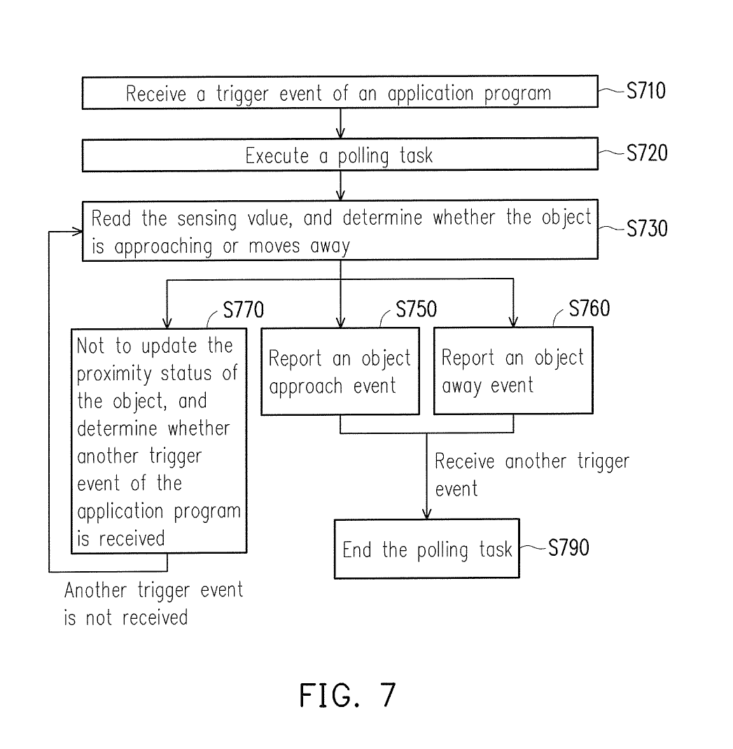

FIG. 6 is a flowchart illustrating a method for determining whether the object is approaching or moves away, which illustrates detailed steps of the step S530 in FIG. 5 or a step S730 in FIG. 7. Referring to FIG. 5 and FIG. 6, in step S610, the control unit 230 determines whether the control unit 230 executes the determination operation of the step S530 of FIG. 5 (or the step S730 of FIG. 7) for the first time. If the control unit 230 executes the determination operation for the first time, the control unit records a first reading time point, and sets the time interval dT, the object approach accumulative time dT_A and the object away accumulative time dT_B to zero (step S620). After the step S620 is completed, the control unit 230 executes a step S630 to perform a read operation to the proximity sensing unit 210 to obtain the sensing value, and determines whether the sensing value is greater than the default value. In some other embodiments, in case that the step S530 of FIG. 5 (or the step S730 of FIG. 7) is determined to be executed for the first time, the control unit 230 can set the time interval dT, the object approach accumulative time dT_A and the object away accumulative time dT_B to zero after performing the read operation to the proximity sensing unit 210.

If the control unit 230 does not execute the determination operation for the first time (for example, the flow return to the step S530 from the step S570 of FIG. 5, or return to the step S730 from the step S770 of FIG. 7), the control unit 230 records a current reading time point, and calculates the time interval dT between the current reading time point and a previous reading time point (step S625). The control unit 230 performs a read operation to the proximity sensing unit 210 to obtain the sensing value, and determines whether the sensing value is greater than the default value (step S630). In some other embodiments, when it is determined that the step S530 of FIG. 5 (or the step S730 of FIG. 7) is not executed for the first time, the control unit 230 can also calculate the time interval dT after performing the read operation to the proximity sensing unit 210.

If the determination result of the step S630 indicates that the sensing value is greater than the default value, the control unit 230 accumulates the time interval dT to the object approach accumulative time dT_A and sets the object away accumulative time dT_B to zero, so as to update the object approach accumulative time dT_A and the object away accumulative time dT_B (step S640). If the determination result of the step S630 indicates that the sensing value is smaller than the default value, the control unit 230 accumulates the time interval dT to the object away accumulative time dT_B and sets the object approach accumulative time dT_A to zero, so as to update the object approach accumulative time dT_A and the object away accumulative time dT_B (step S650).

Then, in step S660, the control unit 230 determines whether the object approach accumulative time dT_A is greater than the default time or the object away accumulative time dT_B is greater than the default time. If the object approach accumulative time dT_A is greater than the default time, the control unit 230 determines that the object is in the approach status (step S670). If the object away accumulative time dT_B is greater than the default time, the control unit 230 determines that the object is in the away status (step S680). On the other hand, if the object approach accumulative time dT_A and the object away accumulative time dT_B are all smaller than the default time, the control unit 230 does not update the proximity status (step S690).

Referring to FIG. 5, if the determination result of the step S530 (shown as the flow of FIG. 6) represents that the object is in the approach status, the control unit 230 further reports an object approach event to the system (step S550). If the determination result of the step S530 (shown as the flow of FIG. 6) represents that the object is in the away status, the control unit 230 further reports an object away event to the system (step S560). After completing the step S550 or the step S560, the control unit 230 ends the polling task (step S590). On the other hand, if the determination result of the step S530 (shown as the flow of FIG. 6) represents that the proximity status of the object is not updated, the control unit 230 waits for a period of time (for example, 0.01 second, 0.005 second, etc.) (step S570), and then returns to the step S530 to execute a next read operation and determination operation.

In the second application situation, FIG. 7 is a flowchart illustrating a trigger mode of an application program. Referring to FIG. 7, the embodiment of FIG. 7 can be deduced by referring to related descriptions of FIG. 5 and FIG. 6. For example, the steps S720, S730, S750, S760, S770, S790 of FIG. 7 can be deduced by referring to related descriptions of the steps S520, S530, S550, S560, S570 and S590 of FIG. 5, and details thereof are not repeated. The step S730 of FIG. 7 may refer to related description of FIG. 6, and a difference between the embodiment of FIG. 7 and the embodiment of FIG. 5 is that in step S710 of FIG. 7, the control unit 230 receives a trigger event of an application program (for example, a phone call is put through, the screen is turned on, etc.). Moreover, in step S770, the control unit 230 further determines whether another trigger event of the application program (for example, the phone call is ended, the screen is turned off, etc.) is received. If the control unit 230 does not receive the another trigger event, the control unit 230 returns from the step S770 to the step S730. Conversely, if the control unit 230 receives the another trigger event, the control unit 230 enters the step S790 from the step S770 to end the polling task.

It should be noted that the first and the second application situations are only examples, and the embodiment of the invention is not limited thereto.

It should be noted that in different application situations, related operations of FIG. 4, FIG. 5, FIG. 6 and/or FIG. 7 can be implemented as software, firmware or hardware by using a general programming language (for example, C or C++), a hardware description language (for example, Verilog HDL or VHDL) or other suitable programming languages. The software (or firmware) capable of executing the related operations can be implemented as any known computer-accessible medium, for example, a magnetic tape, semiconductor, a memory, a magnetic disk or a compact disk (for example, CD-ROM or DVD-ROM), or the software (or firmware) can be transmitted through the Internet, wired communication, wireless communication or other communication media. The software (or firmware) can be stored in a computer-accessible medium, such that a processor of the computer can access/execute programming codes of the software (or firmware). Moreover, in other application situations, the devices and the methods of the invention can be implemented through a combination of hardware and software.

In summary, the proximity sensor and the detection method of the proximity sensor of the invention do not determine the proximity status (for example, the approach status, the away status) of the object directly through the interrupt pins, instead, the status accumulative time is accumulated through one or a plurality of polling tasks, and whether the object is in the approach status or the away status is accordingly determined. In this way, the embodiment of the invention can effectively filter the optical surge measured by the ADC, and provide a more accurate anti-glare algorithm, so as to decrease fabrication cost (for example, a low-class sensing head can be used to increase utilization of the sensing head, so as to decrease film coating cost) and a chip area of the proximity sensing element.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A detection method of a proximity sensor, comprising:
(a) obtaining a sensing value from a proximity sensing unit;
(b) comparing the sensing value and a default value to obtain a comparing result, and calculating a status accumulative time according to the comparing result; and
(c) determining whether the status accumulative time exceeds a default time, so as to determine a proximity status of an object.

2. The detection method as claimed in claim 1, wherein the status accumulative time comprises an object approach accumulative time and an object away accumulative time.

3. The detection method as claimed in claim 2, wherein the step of comparing the sensing value and the default value to obtain the comparing result, and calculating the status accumulative time according to the comparing result comprises:
(b1) determining whether the sensing value is greater than the default value;
(b2) accumulating the object approach accumulative time and initializing the object away accumulative time when the sensing value is greater than the default value; and
(b3) accumulating the object away accumulative time and initializing the object approach accumulative time when the sensing value is smaller than the default value.

4. The detection method as claimed in claim 2, wherein the step of comparing the sensing value and the default value to obtain the comparing result, and calculating the status accumulative time according to the comparing result comprises:
(b4) calculating a time interval between a time point corresponding to a current read operation of the sensing value and a time point corresponding to a previous read operation of the sensing value; and
(b5) accumulating the time interval to the object approach accumulative time or the object away accumulative time.

5. The detection method as claimed in claim 1, further comprising:
(b6) initializing a time interval and the status accumulative time when a read operation of obtaining the sensing value from the proximity sensing unit is executed for the first time.

6. The detection method as claimed in claim 1, further comprising:
(a1) performing a read operation of obtaining the sensing value from the proximity sensing unit for the first time when a control unit receives an interrupt signal generated by the proximity sensing unit in response to approaching of the object or a trigger event triggered by an application program related to the proximity sensing unit.

7. The detection method as claimed in claim 2, wherein the step of determining whether the status accumulative time exceeds the default time, so as to determine the proximity status of the object comprises:
(c1) determining the proximity status to be approach when the object approach accumulative time is greater than the default time; and
(c2) determining the proximity status to be away when the object away accumulative time is greater than the default time.

8. The detection method as claimed in claim 1, wherein the step of determining whether the status accumulative time exceeds the default time comprises:
(c3) not to update the proximity status, and again obtaining an updated sensing value from the proximity sensing unit when the status accumulative time is smaller than the default time.

9. A proximity sensor, comprising:
a proximity sensing unit, configured to generate a sensing value in response to an object; and
a control unit, coupled to the proximity sensing unit, wherein the control unit obtains the sensing value from the proximity sensing unit, compares the sensing value and a default value to obtain a comparing result, calculates a status accumulative time according to the comparing result, and determines whether the status accumulative time exceeds a default time, so as to determine a proximity status of the object.

10. The proximity sensor as claimed in claim 9, wherein the control unit determines whether the sensing value is greater than the default value; when the sensing value is greater than the default value, the control unit accumulates an object approach accumulative time of the status accumulative time, and initializes an object away accumulative time of the status accumulative time; and when the sensing value is smaller than the default value, the control unit accumulates the object away accumulative time, and initializes the object approach accumulative time.

11. The proximity sensor as claimed in claim 9, wherein the control unit calculates a time interval between a time point corresponding to a current read operation of the sensing value and a time point corresponding to a previous read operation of the sensing value, and accumulates the time interval to the status accumulative time.

12. The proximity sensor as claimed in claim 11, wherein when the control unit determines that a read operation of obtaining the sensing value from the proximity sensing unit is executed for the first time, the control unit initializes the time interval and the status accumulative time.

13. The proximity sensor as claimed in claim 11, wherein when the control unit receives an interrupt signal generated by the proximity sensing unit in response to approaching of the object or a trigger event triggered by an application program related to the proximity sensing unit, the control unit performs a read operation of obtaining the sensing value from the proximity sensing unit for the first time.

14. The proximity sensor as claimed in claim 10, wherein the control unit determines the proximity status to be approach when the object approach accumulative time is greater than the default time, and the control unit determines the proximity status to be away when the object away accumulative time is greater than the default time.

15. The proximity sensor as claimed in claim 9, wherein when the status accumulative time is smaller than the default time, the control unit does not update the proximity status, and again obtains an updated sensing value from the proximity sensing unit.

16. The proximity sensor as claimed in claim 9, wherein the proximity sensing unit comprises:
a proximity sensing element, configured to generate a sensing signal in response to the object; and
an analog-to-digital converter, coupled to the proximity sensing element, and converting the sensing signal into the sensing value.
